(19) United States
(12) Patent Application Publication
(10) Pub. No.: US 2025/0052953 A1
(43) Pub. Date: Feb. 13, 2025

(54) OPTICAL CIRCUIT AND METHOD

(71) Applicant: ADVANTEST CORPORATION, Tokyo (JP)

(72) Inventor: Kouichiro UEKUSA, Tokyo (JP)

(21) Appl. No.: 18/929,665

(22) Filed: Oct. 29, 2024

Related U.S. Application Data
(63) Continuation of application No. PCT/JP2022/025660, filed on Jun. 28, 2022.

(51) Int. Cl. G02B 6/35

(52) U.S. Cl. CPC G02B 6/3598; G02B 6/356; G02B 6/3594

(57) ABSTRACT

Provided is an optical circuit comprising: an optical switch that outputs an incident light that is polarized in a first polarization direction to any of a first optical path or a second optical path while keeping a polarization state; a polarization rotation coupling element that is arranged on an output side of each of the first optical path and the second optical path, and converts the incident light that is input from the second optical path into polarized light in a second polarization direction that is orthogonal to the first polarization direction, to output the light from an output port, while outputting, from the output port, the incident light that is input from the first optical path while keeping the polarization state.

The contents of the following patent application(s) are incorporated herein by reference:
NO. PCT/JP2022/025660 filed in WO on Jun. 28, 2022

### BACKGROUND

### 1. Technical Field

The present invention relates to an optical circuit and a method.

### 2. Related Art

Patent document 1 describes that “after respective optical signals that are polarized and separated are aligned to be combined in a single polarization direction, optically branches the combined optical signals, . . . output a probe optical signal by combining the optical signals with different polarization directions.” (paragraph 0047). Patent document 2 describes that “branches continuous light of a TE polarized light . . . modulates the branched continuous light . . . converts the modulated light of the TE polarized light that is modulated into a TM polarized light . . . couples, polarizes and converges the modulated light of the TE polarized light and the TM polarized light to output polarization multiplexed light.” (paragraph 0048).

### PRIOR ART DOCUMENTS

### Patent Document

Patent Document 1: Japanese Patent Application Publication No. 2016-208276
Patent Document 2: Japanese Patent Application Publication No. 2018-40946

### BRIEF DESCRIPTION OF THE DRAWINGS

FIG. 1 is a schematic view of an optical circuit system 10 including an optical circuit 100 according to a first embodiment.

FIG. 2 is a flow diagram showing a method for deciding an applied voltage of an optical switch 110 in the optical circuit 100 according to the first embodiment.

FIG. 3 is a graph for describing an example of a relationship between the applied voltage and an output current value of the optical switch 110.

FIG. 4 is a flow diagram showing a method for specifying a correlation between current values output from light receiving elements 131 and 133 and optical power of light output from the optical circuit 100 for each polarization direction in the optical circuit 100 according to the first embodiment.

FIG. 5 is a flow diagram showing a method for determining a polarization dependency of DUT 60 in the optical circuit 100 according to the first embodiment.

FIG. 6 is a schematic view of an optical circuit system 10 including an optical circuit 200 according to a second embodiment.

FIG. 7 is a schematic view of an optical circuit system 10 including an optical circuit 300 according to a third embodiment.

### DESCRIPTION OF EXEMPLARY EMBODIMENTS

Hereinafter, the present invention will be described through embodiments of the invention, but the following embodiments do not limit the invention according to the claims. In addition, not all of the combinations of features described in the embodiments are essential to the solution of the invention.

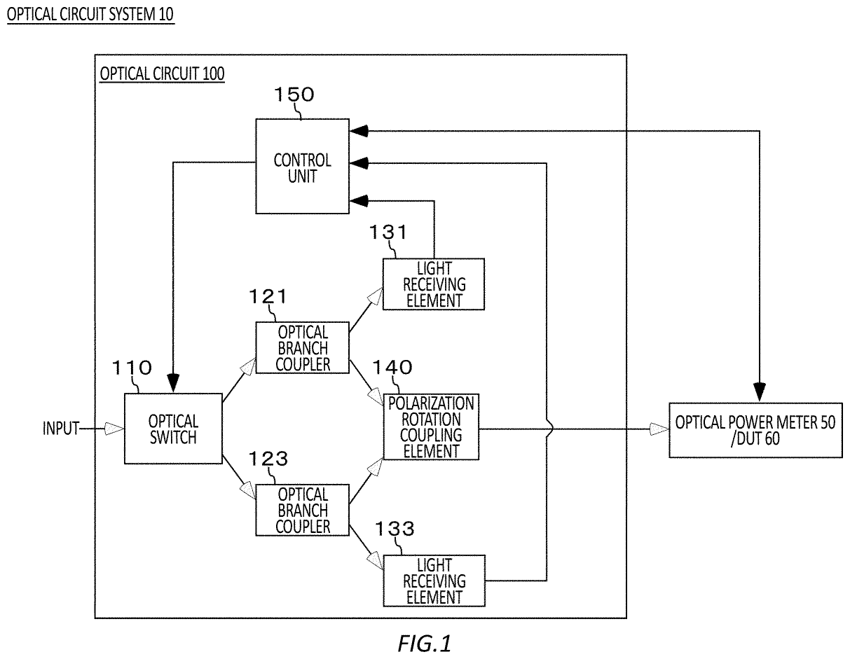

FIG. 1 is a schematic view of an optical circuit system 10 including an optical circuit 100 according to a first embodiment. In FIG. 1, a proceeding direction of guided light is indicated with a hollow arrow, and a flow direction of a signal is indicated with a black arrow. The same applies to the following drawings, and redundant description will be omitted.

The optical circuit system 10 includes an optical circuit 100, an optical power meter 50, and a DUT (device under test) 60. The optical circuit system 10 quickly determines polarization dependency of the DUT 60 by using the optical circuit 100. For determining the polarization dependency of the DUT 60, the optical circuit system 10 arranges the optical power meter 50 in advance at a location in which the DUT 60 is arranged that is on an output side of the optical circuit 100, to detect optical power of light output from the optical circuit 100.

The optical circuit 100 is, for example, a circuit of the optical waveguide type in which an optical fiber is used. Into the optical circuit 100, a TE polarized wave (a plane wave, an electric field of which is orthogonal to an incident surface. An orthogonal polarized wave.) polarized in a first polarization direction is incident. The incident light may be laser light that is oscillated from a DFB laser (distributed feedback laser), for example. A wavelength of the incident light may be approximately 1.3 μm to 1.5 μm, for example.

The optical circuit 100 can output the TE polarized wave polarized in the first polarization direction, and a TM polarized wave (a plane wave, a magnetic field of which is orthogonal to an incident surface. A parallel polarized wave) polarized in a second polarization direction that is orthogonal to the first polarization direction. The optical circuit 100 can quickly switch the polarized wave of the output light from one of the TM polarized wave and the TE polarized wave to another one. That is, according to the optical circuit 100, the polarization dependency of the DUT 60 can be quickly determined.

The optical circuit 100 includes an optical switch 110, optical branch couplers 121 and 123, light receiving elements 131 and 133, a polarization rotation coupling element 140, and a control unit 150.

Into the optical switch 110, an incident light into the optical circuit 100, that is, the TE polarized wave is incident. The optical switch 110 can output the light to two different light paths, that is, each of a first optical path and a second optical path. The optical switch 110 outputs the incident light to any of the first optical path or the second optical path while keeping a polarization state.

The optical switch 110 may be an optical waveguide light switch, for example, or may be an optical switch of Mach-Zehnder type as a specific example. In this case, the optical switch 110 switches a light path on the output side from one of the first optical path and the second optical path to another one according to a magnitude of a voltage that is applied.

The optical branch couplers 121 and 123 are arranged in each of the first optical path and the second optical path that are on the output side of the optical switch 110. The optical branch couplers 121 and 123 are arranged between the optical switch 110 and the polarization rotation coupling element 140. The optical branch couplers 121 and 123 branch parts of the incident light into light paths that are different from a light path to the polarization rotation coupling element 140.

The light receiving elements 131 and 133 receive the respective parts of the incident light that are branched by the optical branch couplers 121 and 123 arranged in each of the first optical path and the second optical path. The light receiving elements 131 and 133 generate currents by photoelectrically converting the received light, and output current values thereof to the control unit 150. The light receiving elements 131 and 133 are arranged in each of the first optical path and the second optical path to at least predetermine the magnitude of the voltage that is applied to the optical switch 110.

The polarization rotation coupling element 140 is arranged on the output side of each of the first optical path and the second optical path. The polarization rotation coupling element 140 has two input ports corresponding to the first optical path and the second optical path, and one output port, as an example. The polarization rotation coupling element 140 may have a different number of output ports according to the number of channels included in the DUT 60. The polarization rotation coupling element 140 outputs, from the output port, while keeping a polarization state, the incident light that is input from the first optical path to one input port and that is polarized in the first polarization direction.

On the other hand, the polarization rotation coupling element 140 outputs, from an output port, the incident light that is input from the second optical path to another input port after being converted into polarized light in a second polarization direction that is orthogonal to the first polarization direction. More specifically, the polarization rotation coupling element 140 performs conversion, for the incident light that is input from the second optical path to another input port, according to a waveguide structure that breaks a symmetry of the first polarization direction, of a basic mode of the incident light into a primary mode of the polarized light in the second polarization direction. The polarization rotation coupling element 140 further performs the conversion, for the incident light after the conversion, of the primary mode of the polarized light in the second polarization direction into a basic mode of the polarized light in the second polarization direction and outputs the light from the output port. Note that, in the optical circuit 100 of the present embodiment, an optical element that actively converts the polarization direction is not arranged on the output side of the polarization rotation coupling element 140, and therefore the light output from the output port of the polarization rotation coupling element 140 corresponds to the light output from the optical circuit 100.

The control unit 150 inputs a control signal into the optical switch 110. In the present embodiment, the control unit 150 applies a voltage to the optical switch 110 in order to switch the light path on the output side of the optical switch 110 of Mach-Zehnder type from one of the first optical path and the second optical path to another one.

Into the control unit 150, current values are input from each of the light receiving elements 131 and 133, the current values being output by each of the light receiving elements 131 and 133 receiving and photoelectrically converting parts of the incident light. In addition, into the control unit 150, a voltage value is input from the optical power meter 50, the voltage value corresponding to optical power of the light output from the optical circuit 100. In addition, the control unit 150 applies a driving voltage to the DUT 60, and a current value from the DUT 60 into which the light from the optical circuit 100 is input is input into the control unit 150.

The optical power meter 50 is arranged on the output side of the optical circuit 100. The optical power meter 50 receives the light output from the optical circuit 100 and detects the intensity, that is, optical power thereof. The optical power meter 50 outputs to the control unit 150 a voltage value corresponding to the optical power that is detected. The optical power meter 50 is detached from the output side of the optical circuit 100 when the polarization dependency of the DUT 60 is determined by using the optical circuit 100.

The DUT 60 is arranged at a location in which the optical power meter 50 is arranged, that is, on the output side of the optical circuit 100. The DUT 60 may be a light transceiver, or a receiving unit of light interface of CPO (Co-Packaged Optics), for example. Into the DUT 60, the light from the optical circuit 100 is input, the DUT 60 being in a driven state by a driving voltage that is applied from the control unit 150, and the DUT 60 outputs the current value corresponding to the intensity of the light to the control unit 150.

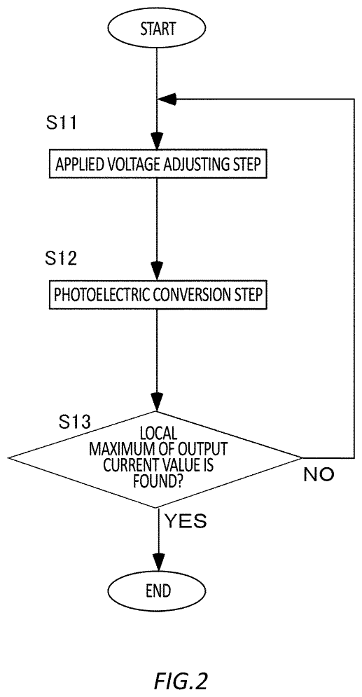

FIG. 2 is a flow diagram showing a method for deciding an applied voltage of an optical switch 110 in the optical circuit 100 according to the first embodiment.

As described above, in the present embodiment, the optical switch 110 may be an optical switch of Mach-Zehnder type. Even if the optical switches of Mach-Zehnder type are created based on the same design, the magnitudes of voltage to be applied for switching the light path on the output side may be different from each other due to variation in a manufacturing process of the optical switch. Therefore, the optical circuit 100 needs to predetermine the magnitude of the voltage when the polarization dependency of the DUT 60 is determined by using the optical switch 110 of Mach-Zehnder type. Note that, in the following description, the voltage may be referred to as an operating point.

The optical circuit 100 according to the present embodiment may perform a method for deciding an applied voltage shown in FIG. 2 as one of previous steps before performing a method for determining the polarization dependency of the DUT 60. The flow of FIG. 2 may be started by starting incidence of a TE polarized wave into an optical circuit 100, for example.

The optical circuit 100 performs an applied voltage adjusting step (step S11). Specifically, the control unit 150 of the optical circuit 100 adjusts a voltage to be applied to the optical switch 110 to which the TE polarized wave is incident.

The optical circuit 100 performs a photoelectric conversion step (step S12). Specifically, the optical circuit 100 outputs, by the light receiving elements 131 and 133, current values by receiving and photoelectrically converting each piece of light passing through the first optical path and the second optical path.

The optical circuit 100 repeats step S11 to step S12 until a local maximum of output current values is found (step S13), and end the flow when the local maximum of the output current values is found. Specifically, the control unit 150 of the optical circuit 100 decides a magnitude of the voltage to be applied to the optical switch 110 for switching the light path on the output side of the optical switch 110 from one of the first optical path and the second optical path to another one based on the current values that change depending on the magnitude of the voltage to be applied to the optical switch 110. For example, the control unit 150 finds the local maximum of the output current values while repeating adjusting the voltage to be applied to the optical switch 110 and monitoring the current values that is output from each of the light receiving elements 131 and 133. The control unit 150 decides the local maximum of the output current values that are found as a magnitude of the voltage to be applied to the optical switch 110 for switching the light path on the output side of the optical switch 110 from one of the first optical path and the second optical path to another one. The control unit 150 stores the magnitude of the voltage that is decided.

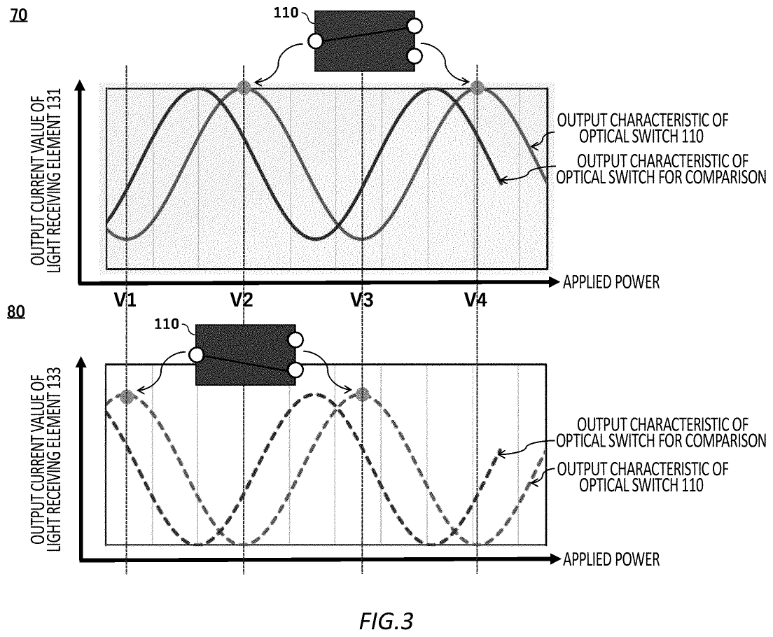

FIG. 3 is a graph for describing an example of a relationship between the applied voltage and output current values of the optical switch 110. In FIG. 3, a horizontal axis of a graph 70 on the upper side refers to an applied voltage, and a vertical axis refers to an output current value of a light receiving element 131. A horizontal axis of a graph 80 on the lower side refers to an applied voltage, and a vertical axis refers to an output current value of a light receiving element 133.

Each of the graph 70 and the graph 80 indicates an output characteristic of the optical switch 110 and an output characteristic of an optical switch for comparison side by side. In the graph 70, the output characteristic is indicated with solid lines, and in the graph 80, the output characteristic is indicated with dashed lines. In the graph 70 and the graph 80, magnitudes of the applied voltage are indicated with linear dashed lines at respective positions of V1, V2, V3, and V4, and a plurality of operating points of the optical switch 110 are indicated with circles on curves indicating the output characteristic of the optical switch 110.

Referring to the graph 70, when the voltages to be applied to the optical switch 110 are V2 and V4, it is understood that the output current value of the light receiving element 131 is the local maximum. In other words, when the applied voltage of the optical switch 110 is V2 or V4, it is understood that the incident light into the optical circuit 100 proceeds to be the closest to a first optical path side on which the light receiving element 131 is arranged.

On the other hand, referring to the graph 80, when the voltages to be applied to the optical switch 110 are V1 and V3, it is understood that the output current value of the light receiving element 133 is the local maximum. In other words, when the applied voltage of the optical switch 110 is V1 or V3, it is understood that the incident light into the optical circuit 100 proceeds to be the closest to a second optical path side on which the light receiving element 133 is arranged.

In this manner, by referring to the output characteristic shown in FIG. 3, it can be decided that the operating points of the optical switch 110 are each of V1, V2, V3, and V4. Note that, as shown in each of the graph 70 and the graph 80, when the optical switch for comparison is arranged in the optical circuit 100 instead of the optical switch 110, the applied voltage at which the output current values of the light receiving elements 131 and 133 is local maximum is different from any of V1, V2, V3, or V4. As described above, this is due to variations in manufacturing processes between the optical switch 110 and the switch for comparison.

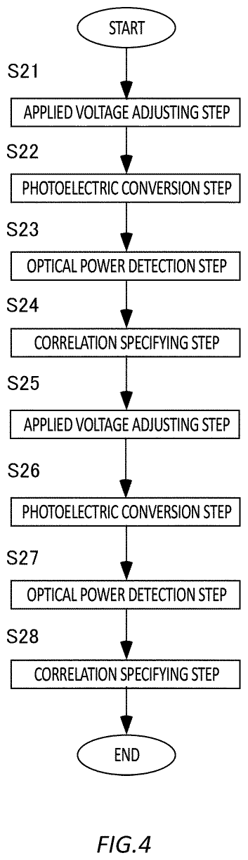

FIG. 4 is a flow diagram showing a method for specifying a correlation between current values output from light receiving elements 131 and 133 and optical power of light output from the optical circuit 100 for each polarization direction in the optical circuit 100 according to the first embodiment. The optical circuit 100 according to the present embodiment may perform a method for specifying the correlation shown in FIG. 4 as one of previous steps before performing a method for determining the polarization dependency of the DUT 60. When the method for specifying the correlation shown in FIG. 4 is performed, the optical power meter 50 rather than the DUT 60 is arranged on the output side of the optical circuit 100.

When performing the method for determining the polarization dependency of the DUT 60, the DUT 60 rather than the optical power meter 50 is arranged on the output side of the optical circuit 100. In this case, because the optical power meter 50 cannot detect the optical power of the output light, the optical circuit 100 needs to estimate the optical power of the light input into the DUT 60. Therefore, as an example, the optical circuit 100 may specify in advance a correlation between the optical power of the output light detected by the optical power meter 50 and current values from the light receiving elements 131 and 133. In this way, when the DUT 60 is arranged on the output side of the optical circuit 100 instead of the optical power meter 50, the optical circuit 100 may calculate the optical power of the light input into the DUT 60 based on the correlation, and the current values from the light receiving elements 131 and 133.

In the description of the flow in FIG. 4, as an example, a correlation specification when the optical path is switched into the first optical path by the optical switch 110 is previously performed, and subsequently, a correlation specification when the optical path is switched into the second optical path by the optical switch 110 is performed, but the flow may be performed in reverse order. The flow of FIG. 4 may be started by starting incidence of a TE polarized wave into an optical circuit 100, for example.

The optical circuit 100 performs an applied voltage adjusting step (step S21). Specifically, the control unit 150 of the optical circuit 100 applies a voltage at V2 or V4 to the optical switch 110 to which the TE polarized wave is incident, to make the incident light progress into the optical circuit 100 closer to the first optical path side.

The optical circuit 100 performs a photoelectric conversion step (step S22). Specifically, the optical circuit 100 outputs, by the light receiving element 131, a current value by receiving and photoelectrically converting light passing through the first optical path.

The optical circuit 100 performs an optical power detection step (step S23). Specifically, the optical circuit 100 receives the light output from the polarization rotation coupling element 140, that is, the TE polarized wave, by the optical power meter 50, to detect the intensity, that is, the optical power thereof. The optical power meter 50 outputs to the control unit 150 a voltage value corresponding to the optical power that is detected.

The optical circuit 100 performs a correlation specifying step (step S24). Specifically, the control unit 150 of the optical circuit 100 specifies a correlation between the current value output by the light receiving element 131 receiving and photoelectrically converting a part of the incident light and optical power of the TE polarized wave output from the polarization rotation coupling element 140. The control unit 150 stores, for the TE polarized wave, a function indicating the correlation that is specified, a conversion table between the current value and the optical power based on the correlation that is specified, or the like.

The optical circuit 100 performs an applied voltage adjusting step (step S25). Specifically, the control unit 150 of the optical circuit 100 applies a voltage at V1 or V3 to the optical switch 110 to which the TE polarized wave is incident, to make the incident light progress into the optical circuit 100 closer to the second optical path side.

The optical circuit 100 performs a photoelectric conversion step (step S26). Specifically, the optical circuit 100 outputs, by the light receiving element 133, a current value by receiving and photoelectrically converting light passing through the second optical path.

The optical circuit 100 performs an optical power detection step (step S27). Specifically, the optical circuit 100 receives the light output from the polarization rotation coupling element 140, that is, the TM polarized wave, by the optical power meter 50, to detect the intensity, that is, the optical power thereof. The optical power meter 50 outputs to the control unit 150 a voltage value corresponding to the optical power that is detected.

The optical circuit 100 performs a correlation specifying step (step S28), and ends the flow. Specifically, the control unit 150 of the optical circuit 100 specifies a correlation between the current value output by the light receiving element 133 receiving and photoelectrically converting a part of the incident light and optical power of the TM polarized wave output from the polarization rotation coupling element 140. The control unit 150 stores, for the TM polarized wave, a function indicating the correlation that is specified, a conversion table between the current value and the optical power based on the correlation that is specified, or the like.

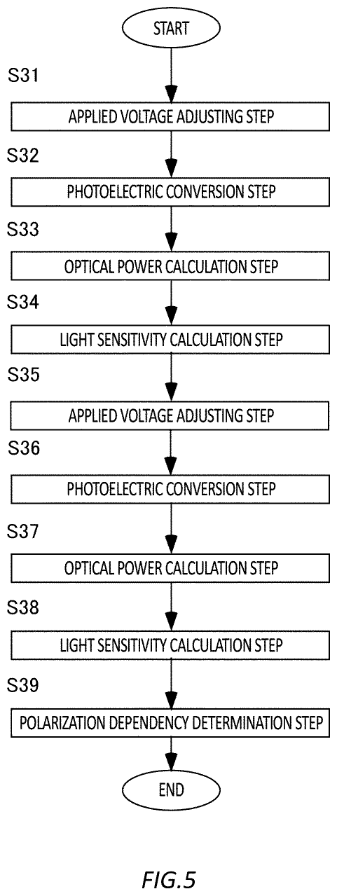

FIG. 5 is a flow diagram showing a method for determining a polarization dependency of DUT 60 in the optical circuit 100 according to the first embodiment. In the description of the flow in FIG. 5, as an example, a polarization dependency determination when the optical path is switched into the first optical path by the optical switch 110 is previously performed, and subsequently, a polarization dependency determination when the optical path is switched into the second optical path by the optical switch 110 is performed, but the flow may be performed in reverse order.

When performing the method for determining the polarization dependency shown in FIG. 5, the DUT 60 rather than the optical power meter 50 is arranged on the output side of the optical circuit 100. The flow in FIG. 5 may be started by starting incidence of the TE polarized wave into an optical circuit 100 in a state in which the control unit 150 of the optical circuit 100 applies a driving voltage to the DUT 60, for example.

The optical circuit 100 performs an applied voltage adjusting step (step S31). Specifically, the control unit 150 of the optical circuit 100 applies a voltage at V2 or V4 to the optical switch 110 to which the TE polarized wave is incident, to make the incident light progress into the optical circuit 100 closer to the first optical path side.

The optical circuit 100 performs a photoelectric conversion step (step S32). Specifically, the optical circuit 100 outputs, by the light receiving element 131, a current value by receiving and photoelectrically converting light passing through the first optical path.

The optical circuit 100 performs an optical power calculation step (step S33). Specifically, the control unit 150 of the optical circuit 100 calculates optical power of the TE polarized wave output from the polarization rotation coupling element 140 based on the above-described correlation that is related to the TE polarized wave and a current value of the light receiving element 131 obtained by a new incident light. The correlation may be specified by performing the method for specifying the correlation of FIG. 4 in advance, for example.

The optical circuit 100 performs a light sensitivity calculation step (step S34). Specifically, with respect to the TE polarized wave, the control unit 150 of the optical circuit 100 calculates a light sensitivity of the DUT 60 by dividing, by optical power that is calculated in step S33, a current value output from the DUT 60 that is arranged on an output side of the optical circuit 100 and to which the new incident light is input.

The optical circuit 100 performs an applied voltage adjusting step (step S35). Specifically, the control unit 150 of the optical circuit 100 applies a voltage at V1 or V3 to the optical switch 110 to which the TE polarized wave is incident, to make the incident light progress into the optical circuit 100 closer to the second optical path side.

The optical circuit 100 performs a photoelectric conversion step (step S36). Specifically, the optical circuit 100 outputs, by the light receiving element 133, a current value by receiving and photoelectrically converting light passing through the second optical path.

The optical circuit 100 performs an optical power calculation step (step S37). Specifically, the control unit 150 of the optical circuit 100 calculates optical power of the TM polarized wave output from the polarization rotation coupling element 140 based on the above-described correlation that is related to the TM polarized wave and a current value of the light receiving element 133 obtained by a new incident light. The correlation may be specified by performing the method for specifying the correlation of FIG. 4 in advance, for example.

The optical circuit 100 performs a light sensitivity calculation step (step S38). Specifically, with respect to the TM polarized wave, the control unit 150 of the optical circuit 100 calculates a light sensitivity of the DUT 60 by dividing, by optical power that is calculated in step S37, a current value output from the DUT 60 that is arranged on an output side of the optical circuit 100 and to which the new incident light is input.

The optical circuit 100 performs a polarization dependency determination step (step S39), and ends the flow. Specifically, the control unit 150 determines the polarization dependency of the DUT 60 based on the light sensitivity that is calculated with respect to each of the TM polarized wave and the TE polarized wave. For example, the control unit 150 may determine that the polarization dependency of the DUT 60 is larger as a difference between the light sensitivity of the DUT 60 when the TE polarized wave is input to the DUT 60 and the light sensitivity of the DUT 60 when the TM polarized wave is input to the DUT 60 is larger. The control unit 150 may output data indicating the determination result to a device or the like outside.

As described above, according to the optical circuit 100 according to the present embodiment, by the optical switch 110, the incident light polarized in the first polarization direction is output to any of the first optical path or the second optical path while keeping the polarization state. According to the optical circuit 100 according to the present embodiment, when the incident light is input from the first optical path to a polarization rotation coupling element 140, the incident light is output from an output port of the polarization rotation coupling element 140 while keeping the polarization state. According to the optical circuit 100 according to the present embodiment, when the incident light is input from the second optical path to the polarization rotation coupling element 140, the incident light is converted into polarized light in a second polarization direction that is orthogonal to the first polarization direction by the polarization rotation coupling element 140, and output the light from the output port of the polarization rotation coupling element 140.

According to the optical circuit 100 of the present embodiment including such a configuration, a light path on the output side of the optical switch 110 can be quickly switched, that is, a polarization direction of the light output from the optical circuit 100 can be quickly switched. Therefore, by arranging the DUT 60 on the output side of the optical circuit 100, the polarization dependency of the DUT 60 can be quickly determined.

In the description above, the optical circuit 100 according to the present embodiment is described as an optical circuit that may perform the method for deciding the applied voltage shown in FIG. 2 or the method for specifying the correlation shown in FIG. 4 as a previous step before performing the method for determining the polarization dependency of the DUT 60 shown in FIG. 5. The optical circuit 100 may perform the method for deciding the applied voltage shown in FIG. 2 or the method for specifying the correlation shown in FIG. 4 every time the method for determining the polarization dependency of the DUT 60 shown in FIG. 5 is performed for plurality of DUTs 60 by a predetermined number of times. The optical circuit 100 may not perform the method for deciding the applied voltage shown in FIG. 2 when the magnitude of the voltage to be applied for switching the light path on the output side is acquired in advance by any method. Similarly, the optical circuit 100 may not perform the method for specifying the correlation shown in FIG. 4 when the correlation for each polarization direction is acquired in advance by any method.

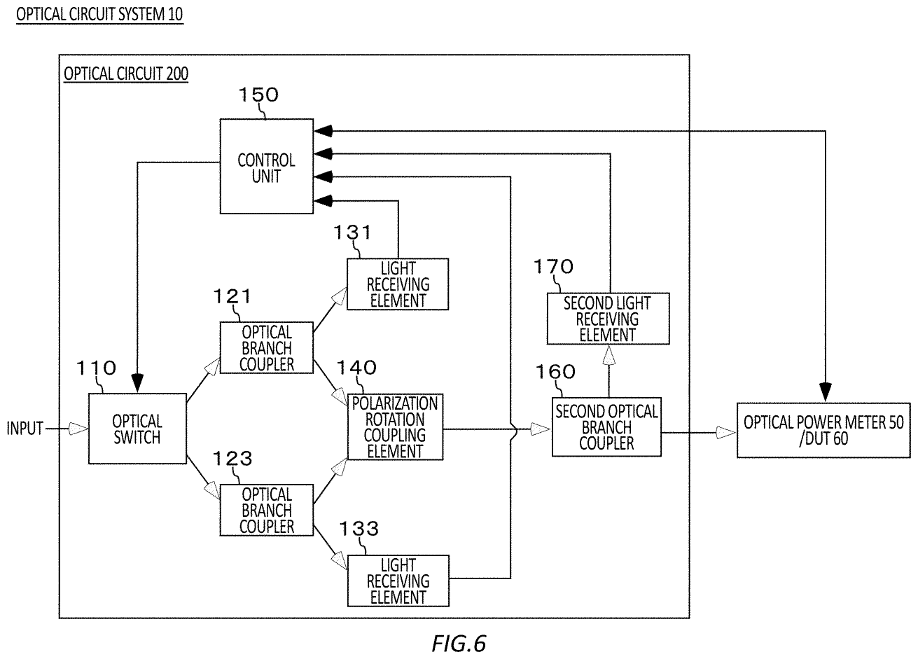

FIG. 6 is a schematic view of an optical circuit system 10 including an optical circuit 200 according to a second embodiment. The optical circuit 200 according to the present embodiment includes, as a difference from the optical circuit 100 according to the first embodiment, a second optical branch coupler 160 and a second light receiving element 170, in addition to a configuration including the optical circuit 100 according to the first embodiment. Other configurations in the optical circuit 200 are the same as the corresponding configurations in the optical circuit 100, and thus the same reference numerals are used to omit redundant descriptions. The same applies to a plurality of embodiments described below.

The second optical branch coupler 160 is arranged on an output side of the polarization rotation coupling element 140. The second optical branch coupler 160 branches a part of the light output from the polarization rotation coupling element 140 into a light path that is different from a light path to an output side of the optical circuit 200.

The second light receiving element 170 receives the light that is branched by the second optical branch coupler 160. The second light receiving element 170 generates currents by photoelectrically converting the received light, and output current values thereof to the control unit 150. The second light receiving element 170 is arranged for specifying in advance a correlation between the current value output by the second light receiving element 170 receiving and photoelectrically converting the light and optical power of light output to the output side of the optical circuit 200.

In the present embodiment, the control unit 150 specifies in advance the correlation by using a current value from the second light receiving element 170 in each state in which the optical switch 110 is switching into each of the first optical path and the second optical path. Unlike the first embodiment, the control unit 150 does not use the current values from each of the light receiving elements 131 and 133 for specifying the correlation in advance.

The control unit 150 further calculates the optical power of the light output to the output side of the optical circuit 200 based on the correlation in each state and the current value from the second light receiving element 170 obtained by new incident light. Unlike the first embodiment, the control unit 150 does not use the current values from each of the light receiving elements 131 and 133 for calculating the optical power.

According to the optical circuit 200 according to the present embodiment, a similar effect as that of the optical circuit 100 according to the first embodiment is caused

According to the optical circuit 200 according to the present embodiment, reliability of the optical power that is calculated can be increased more than that of the optical circuit 100 according to the first embodiment because a part of the output light of the optical circuit 200 is directly received by the second light receiving element 170 to output the current value, and the optical power of the output light of the optical circuit 200 is calculated based on the current value.

Note that in the optical circuit 200 according to the present embodiment, the light receiving elements 131 and 133 and the optical branch couplers 121 and 123 are arranged to decide a voltage at an operating point that is required to switch the light path on the output side of the optical switch 110. Accordingly, the light receiving elements 131 and 133 and the optical branch couplers 121 and 123 may be detached from the optical circuit 200 after deciding the voltage.

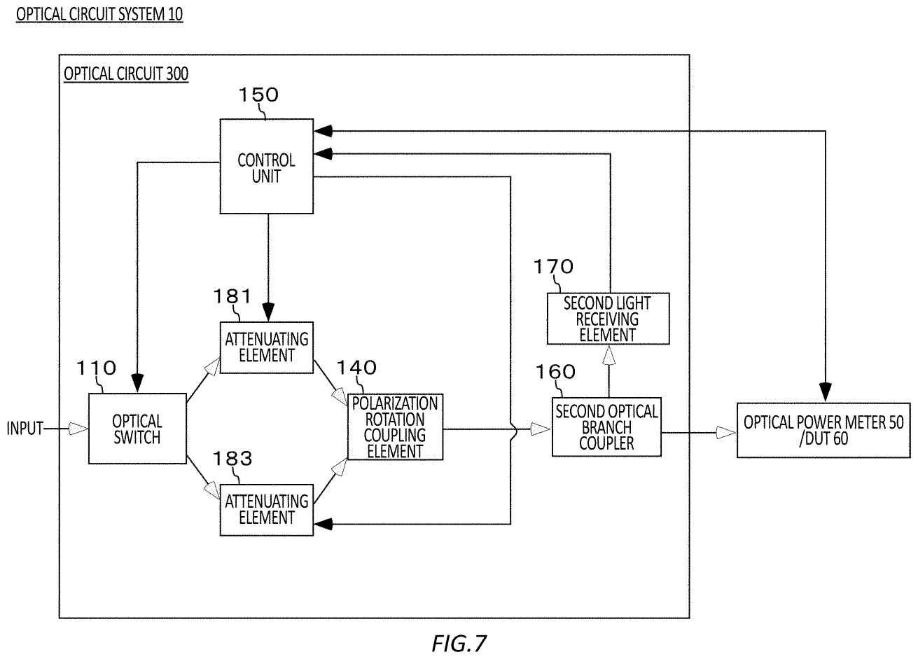

FIG. 7 is a schematic view of an optical circuit system 10 including an optical circuit 300 according to a third embodiment. As a difference from the optical circuit 200 according to the second embodiment, the optical circuit 300 according to the present embodiment does not include the light receiving elements 131 and 133 and the optical branch couplers 121 and 123 included in the optical circuit 200 of the second embodiment, but alternatively includes attenuating elements 181 and 183. Other components in the optical circuit 300 are the same as corresponding components of the optical circuit 200.

The attenuating elements 181 and 183 are arranged in each of the first optical path and the second optical path. The attenuating elements 181 and 183 are elements that can adjust an attenuation amount by which the light about to pass through the attenuating elements 181 and 183 is attenuated. The attenuating elements 181 and 183 control the attenuation amount by the control unit 150.

The attenuating elements 181 and 183 pass the incident light propagating through each of the first optical path and the second optical path without attenuating or attenuate and block the light.

Specifically, the attenuating element 181 arranged in the first optical path passes the incident light propagating through the first optical path without attenuating when an attenuation amount of 0 db is set by the control unit 150. The attenuating element 181 attenuates and blocks the incident light propagating through the first optical path when an attenuation amount of 20 dB, for example, is set by the control unit 150. The attenuating element 181 may set a higher attenuation amount such as 30 dB, 40 dB, or the like by the control unit 150 in order to increase the precision of attenuating and blocking the incident light propagating through the first optical path.

Similarly, the attenuating element 183 arranged in the second optical path passes the incident light propagating the second optical path without attenuating when an attenuation amount of 0 db is set by control unit 150. The attenuating element 183 attenuates and blocks the incident light propagating through the second optical path when an attenuation amount of 20 dB, for example, is set by the control unit 150. The attenuating element 183 may set a higher attenuation amount such as 30 dB, 40 dB, or the like by the control unit 150 in order to increase the precision of attenuating and blocking the incident light propagating through the second optical path.

In the optical circuit 300 according to the present embodiment, in order to predetermine a magnitude of a voltage to be applied to the optical switch 110, the attenuating elements 181 and 183 are sequentially put in a blocking state, and then the incident light from each of the first optical path and the second optical path is received at the second light receiving element 170. More specifically, by adjusting the attenuation amount of each of the attenuating elements 181 and 183, the control unit 150 of the optical circuit 300 switches between a first state in which the incident light of the first optical path is passed without attenuating by the attenuating element 181 and the incident light of the second optical path is attenuated and blocked by the attenuating element 183, and a second state in which the incident light of the first optical path is attenuated and blocked by the attenuating element 181 and the incident light of the second optical path is passed without attenuating by the attenuating element 183. The second light receiving element 170 receives the light branched by the second optical branch coupler 160 in each of the first state and the second state.

The control unit 150 of the optical circuit 300 may specify in advance, in each of the first state and the second state, a correlation between a current value output by the second light receiving element 170 receiving and photoelectrically converting the light and optical power of light output to the output side of the optical circuit 300. The control unit 150 of the optical circuit 300 may further calculate the optical power of the light output to the output side of the optical circuit 300 based on the correlation of each of the first state and the second state and the current value from the second light receiving element 170 obtained by new incident light.

According to the optical circuit 300 according to the present embodiment, a similar effect as that of the optical circuit 100 according to the first embodiment and the optical circuit 200 according to the second embodiment is caused

Note that in the optical circuit 300 according to the present embodiment, the attenuating elements 181 and 183 are arranged to at least decide a voltage at an operating point that is required to switch the light path on the output side of the optical switch 110. Accordingly, the attenuating elements 181 and 183 may be detached from the optical circuit 300 after deciding the voltage. In this case, the control unit 150 of the optical circuit 300 specifies the above-described correlation or calculates the above-described optical power in a state in which the optical switch 110 switches between each of the first optical path and the second optical path instead of the above-described first state and the second state.

In the plurality of embodiments above, the optical switch of Mach-Zehnder type which is an example of an optical waveguide light switch is described as the optical switch of the optical circuit. Alternatively, as the optical switch of the optical circuit, a directional coupler, and optical switch of digital type, cross-type, or the like that are another example of the optical waveguide light switch may be used, or an optical switch of mechanical type or MEMS may be used. When an optical switch other than the optical switch of Mach-Zehnder type is used as the optical switch of the optical circuit, in the second embodiment and the third embodiment described above, the optical branch couplers 121 and 123 and the light receiving elements 131 and 133 may not be arranged in each of the first optical path and the second optical path. Note that even if the optical switch other than the optical switch of Mach-Zehnder type is used as the optical switch of the optical circuit, when the magnitude of voltage to be applied for switching the light path on the output side is different due to variation in a manufacturing process of the optical switch, an arrangement configuration in the second embodiment and the third embodiment described above may be maintained.

While the present invention has been described by way of the embodiments, the technical scope of the present invention is not limited to the scope described in the above-described embodiments. It is apparent to persons skilled in the art that various alterations or improvements can be made to the above-described embodiments. It is also apparent from the described scope of the claims that the embodiments added with such alterations or improvements can be included in the technical scope of the present invention.

The operations, procedures, steps, stages, or the like of each process performed by a device, system, program, and method shown in the claims, embodiments, or diagrams can be realized in any order as long as the order is not indicated by “prior to,” “before,” or the like and as long as the output from a previous process is not used in a later process. Even if the process flow is described using phrases such as “first” or “next” in the claims, embodiments, or diagrams, it does not necessarily mean that the process must be performed in this order.

### EXPLANATION OF REFERENCES

10 optical circuit system
50 optical power meter
60 DUT
100, 200, 300 optical circuit
110 optical switch
121, 123 optical branch coupler
131, 133 light receiving element
140 polarization rotation coupling element
150 control unit
160 second optical branch coupler
170 second light receiving element
181, 183 attenuating element.

What is claimed is:

1. An optical circuit comprising:
an optical switch that outputs an incident light that is polarized in a first polarization direction to any of a first optical path or a second optical path while keeping a polarization state; and
a polarization rotation coupling element that is arranged on an output side of each of the first optical path and the second optical path, and converts the incident light that is input from the second optical path into polarized light in a second polarization direction that is orthogonal to the first polarization direction, to output the light from an output port, while outputting, from the output port, the incident light that is input from the first optical path while keeping the polarization state.

2. The optical circuit according to claim 1, wherein the optical switch is an optical switch of Mach-Zehnder type that switches a light path on the output side from one of the first optical path and the second optical path to another one according to a magnitude of a voltage that is applied.

3. The optical circuit according to claim 2, further comprising:
optical branch couplers that are arranged in each of the first optical path and the second optical path and branch parts of the incident light to a light path that is different from a light path to the polarization rotation coupling element; and
light receiving elements that receive, in order to predetermine a magnitude of a voltage to be applied to the optical switch, each part of the incident light that is branched by the optical branch couplers arranged in each of the first optical path and the second optical path.

4. The optical circuit according to claim 3, further comprising a control unit that specifies in advance a correlation between current values output by each of the light receiving elements receiving and photoelectrically converting the parts of the incident light and optical power of light output from the polarization rotation coupling element, and calculates the optical power of the light output from the polarization rotation coupling element based on the correlation and each of the current values obtained by new incident light.

5. The optical circuit according to claim 1, further comprising:
optical branch couplers that are arranged in each of the first optical path and the second optical path and branch parts of the incident light to a light path that is different from a light path to the polarization rotation coupling element;
light receiving elements that receive each part of the incident light that is branched by the optical branch couplers arranged in each of the first optical path and the second optical path; and
a control unit that specifies in advance a correlation between current values output by each of the light receiving elements receiving and photoelectrically converting the parts of the incident light and optical power of light output from the polarization rotation coupling element, and calculates the optical power of the light output from the polarization rotation coupling element based on the correlation and each of the current value obtained by new incident light.

6. The optical circuit according to claim 3, further comprising:
a second optical branch coupler that is arranged on an output side of the polarization rotation coupling element and branch parts of light output from the polarization rotation coupling element to a light path that is different from a light path on an output side of the optical circuit; and
a second light receiving element that receives a part of the light that is branched by the second optical branch coupler, and is arranged for specifying in advance a correlation between a current value that is output by the second light receiving element receiving and photoelectrically converting the part of the light and optical power of light output to the output side of the optical circuit.

7. The optical circuit according to claim 6, further comprising a control unit that specifies in advance the correlation in each state in which the optical switch is switching between each of the first optical path and the second optical path, and calculates the optical power of the light output to the output side of the optical circuit based on the correlation in each state and the current value from the second light receiving element obtained by new incident light.

8. The optical circuit according to claim 2, further comprising:
attenuating elements that is arranged in each of the first optical path and the second optical path, and passes the incident light propagating through each of the first optical path and the second optical path without attenuating or attenuates and blocks the light;
optical branch couplers that are arranged on output sides of the polarization rotation coupling element and branch parts of light output from the polarization rotation coupling element to a light path that is different from a light path on an output side of the optical circuit; and
light receiving elements that receive the parts of the light that is branched by the optical branch couplers, in order to predetermine a magnitude of a voltage to be applied to the optical switch, in each of a first state in which the incident light of the first optical path is passed without attenuating and the incident light of the second optical path is attenuated and blocked by the attenuating elements and a second state in which the incident light of the first optical path is attenuated and blocked and the incident light of the second optical path is passed without attenuating by the attenuating elements.

9. The optical circuit according to claim 8, further comprising a control unit that specifies in advance, in each of the first state and the second state, a correlation between current values output by the light receiving elements receiving and photoelectrically converting the parts of the light and optical power of light output to the output side of the optical circuit, and calculates the optical power of the light output to the output side of the optical circuit based on the correlation of each of the first state and the second state and the current value obtained by new incident light.

10. The optical circuit according to claim 1, further comprising:
optical branch couplers that are arranged on an output side of the polarization rotation coupling element and branches parts of light output from the polarization rotation coupling element to a light path that is different from a light path on an output side of the optical circuit;
light receiving elements that receive the parts of the light that are branched by the optical branch couplers; and
a control unit that specifies in advance, in each state in which the optical switch is switching between each of the first optical path and the second optical path, a correlation between current values output by the light receiving elements receiving and photoelectrically converting the parts of the light and optical power of light output to an output side of the optical circuit, and calculates the optical power of the light output to the output side of the optical circuit based on the correlation of each state and the current values from the light receiving elements obtained by new incident light.

11. The optical circuit according to claim 4, wherein the control unit calculates, with respect to each of polarized light in the first polarization direction and polarized light in the second polarization direction, a light sensitivity of a device under test by dividing, by the optical power that is calculated, a current value output from the device under test, to accordingly determine a polarization dependency of the device under test, the device under test being arranged on an output side of the optical circuit and to which the new incident light is input.

12. The optical circuit according to claim 5, wherein the control unit calculates, with respect to each of polarized light in the first polarization direction and polarized light in the second polarization direction, a light sensitivity of a device under test by dividing, by the optical power that is calculated, a current value output from the device under test, to accordingly determine a polarization dependency of the device under test, the device under test being arranged on an output side of the optical circuit and to which the new incident light is input.

13. The optical circuit according to claim 7, wherein the control unit calculates, with respect to each of polarized light in the first polarization direction and polarized light in the second polarization direction, a light sensitivity of a device under test by dividing, by the optical power that is calculated, a current value output from the device under test, to accordingly determine a polarization dependency of the device under test, the device under test being arranged on an output side of the optical circuit and to which the new incident light is input.

14. The optical circuit according to claim 9, wherein the control unit calculates, with respect to each of polarized light in the first polarization direction and polarized light in the second polarization direction, a light sensitivity of a device under test by dividing, by the optical power that is calculated, a current value output from the device under test, to accordingly determine a polarization dependency of the device under test, the device under test being arranged on an output side of the optical circuit and to which the new incident light is input.

15. The optical circuit according to claim 10, wherein the control unit calculates, with respect to each of polarized light in the first polarization direction and polarized light in the second polarization direction, a light sensitivity of a device under test by dividing, by the optical power that is calculated, a current value output from the device under test, to accordingly determine a polarization dependency of the device under test, the device under test being arranged on an output side of the optical circuit and to which the new incident light is input.

16. The optical circuit according to claim 1, wherein the polarization rotation coupling element performs conversion, for the incident light that is input from the second optical path, according to a waveguide structure that breaks a symmetry of the first polarization direction, of a basic mode of the incident light into a primary mode of the polarized light in the second polarization direction, and further converts the primary mode of the polarized light in the second polarization direction into a basic mode of the polarized light in the second polarization direction.

17. A method comprising:
outputting, by an optical switch, an incident light that is polarized in a first polarization direction to any of a first optical path or a second optical path while keeping a polarization state; and
outputting, when the incident light is input from the first optical path to a polarization rotation coupling element, the incident light from an output port of the polarization rotation coupling element while keeping the polarization state, and converting, when the incident light is input from the second optical path to the polarization rotation coupling element, the incident light into polarized light in a second polarization direction that is orthogonal to the first polarization direction by the polarization rotation coupling element, to output the light from the output port of the polarization rotation coupling element.

18. The method according to claim 17, wherein
the optical switch is an optical switch of Mach-Zehnder type that switches a light path on an output side from one of the first optical path and the second optical path to another one according to a magnitude of a voltage that is applied, and further comprising:
outputting, by light receiving elements, current values by receiving and photoelectrically converting light passing through the first optical path and the second optical path; and
deciding a magnitude of a voltage to be applied to the optical switch for switching a light path on the output side of the optical switch from one of the first optical path and the second optical path to another one based on the current values that change depending on the magnitude of the voltage to be applied to the optical switch.

19. The method according to claim 17, further comprising:
outputting, by light receiving elements, current values by receiving and photoelectrically converting light passing through the first optical path and the second optical path;
specifying a correlation between the current values and optical power of light output from the polarization rotation coupling element; and
calculating the optical power of the light output from the polarization rotation coupling element based on the correlation and the current value obtained by new incident light.

20. The method according to claim 19, further comprising
calculating, with respect to each of polarized light in the first polarization direction and polarized light in the second polarization direction, a light sensitivity of a device under test by dividing, by the optical power that is calculated, a current value output from the device under test, to accordingly determine a polarization dependency of the device under test, the device under test being arranged on an output side of the polarization rotation coupling element and to which the new incident light is input.
